(19) United States
(12) Patent Application Publication
(10) Pub. No.: US 2002/0021873 A1
(43) Pub. Date: Feb. 21, 2002

(54) Plug and system for the electrical connection of mounting racks in the switching sector

(76) Inventor: Klaus Patzelt, Munchen (DE)

Correspondence Address: STAAS & HALSEY LLP, 700 11TH STREET, NW, SUITE 500, WASHINGTON, DC, 20001, US

(21) Appl. No.: 09/924,780

(22) Filed: Aug. 9, 2001

(30) Foreign Application Priority Data
Aug. 9, 2000 (DE) 100 38 898.1

(51) Int. Cl. G02B 6/42; G02B 6/36

(52) U.S. Cl. 385/88; 385/75

(57) ABSTRACT

A plug and a system provide for the electrical connection of mounting racks in the switching sector. At least one optical transmission cable can be connected to the plug. An electrooptical converter is accommodated in the housing of the plug itself.

### CROSS REFERENCE TO RELATED APPLICATIONS

This application is based on and hereby claims priority to German Application No. 10038898.1 filed on Aug. 9, 2000 in Germany, the contents of which are hereby incorporated by reference.

### BACKGROUND OF THE INVENTION

The present invention relates to a plug and a system for the electrical connection of mounting racks in the switching sector. The invention generally relates to electrical contact-making devices for electrical or optical connections.

It is currently usual to provide both optical and electrical possible contact-making device on the backplane of mounting racks in the switching matrix of a switching center. The disadvantage in this case is that one possible contact-making device (optical or electrical) becomes superfluous if the user decides to use the respective other possible contact-making device. The space therefore has to be divided up for two disjunct solutions.

According to the currently used devices, in addition to the electrical contact-making devices 5 in FIG. 1, optical contact-making devices are also provided. Electrical signals are transmitted to the mounting rack via an electric plug and vice versa. The optical contact-making device, in spite of all the space which it takes up, is not used in the case of electrical transmission.

Optical signals are transmitted to the optical contact-making device by optical waveguides and are then converted into appropriate electrical signals in the switching matrix. In this case, the electrical contact-making device 5 in FIG. 1, which takes up the same amount of space, is not used.

A further problem in the current devices is that the integration of the subassemblies is continuing, but unfortunately no corresponding reduction in the size of the mounting racks can be carried out, since the contact-making devices still need too much space. In addition, a higher integration density is limited by the “low bit-rate” electrical and optical interfaces.

In view of the aforementioned difficulties, it is an object of the present invention to provide a technique which permits a reduction in the space requirement of the contact-making devices of the mounting racks.

### SUMMARY OF THE INVENTION

According to the invention, this object is achieved firstly by a plug and secondly by a system for the electrical connection of mounting racks.

According to one aspect of the invention, in the housing of the plug, to which at least one optical transmission cable can be connected, there is an electrooptical converter.

As a result, only electrical subassemblies are advantageously still needed. Nevertheless, optical transmission is possible. Therefore, optical or electrical connection can be made as desired.

The electrical contact-making device of the electrooptical converter are connected by a printed circuit board to plug contacts at the front end of the plug.

Active and/or passive components are arranged on the printed circuit board.

The components can be used for data partitioning, data selection and/or for fault monitoring.

At least some of the plug contacts on the front end of the plug are designed for the voltage supply of active components.

According to one aspect of the invention, furthermore, a system for the optional electrical or optical connection of at least one mounting rack in a switching system is claimed. The connection is made via a plug mentioned and described above. In this case, the mounting rack has standardized electrical contact-making devices for the electrical or optical connection.

The pin allocation of the electrical contact-making devices is suitable for the electrical and optical connection. In this way, an optical or electrical connection can be made on each electrical contact-making device of the mounting racks as desired.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows schematically the switching matrix of a digital switching center, with the corresponding electrical contact-making devices of the mounting rack. Also shown are an electrical and an optical plug/transceiver.

FIG. 2 shows the rear of the housing of the digital switching center with the electrical contact-making devices of the mounting rack.

FIG. 3A is a cross-sectional side view,

FIG. 3B is a cross-sectional plan view and

FIG. 3C is a front, customer connection side, view of an electrical plug/transceiver used as a coupling element between the customer side and switching matrix.

FIG. 4A is a side cross-sectional view,

FIG. 4B is a cross-sectional plan view and

FIG. 4C is a front view on the customer side, of an optical plug/transceiver used as coupling element between the customer side and switching matrix.

FIG. 5A shows how four optical plugs/transceivers can be arranged over a length of 50 mm, and

FIG. 5B shows how sixteen electrical plugs/transceivers can be arranged over a length of 300 mm.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

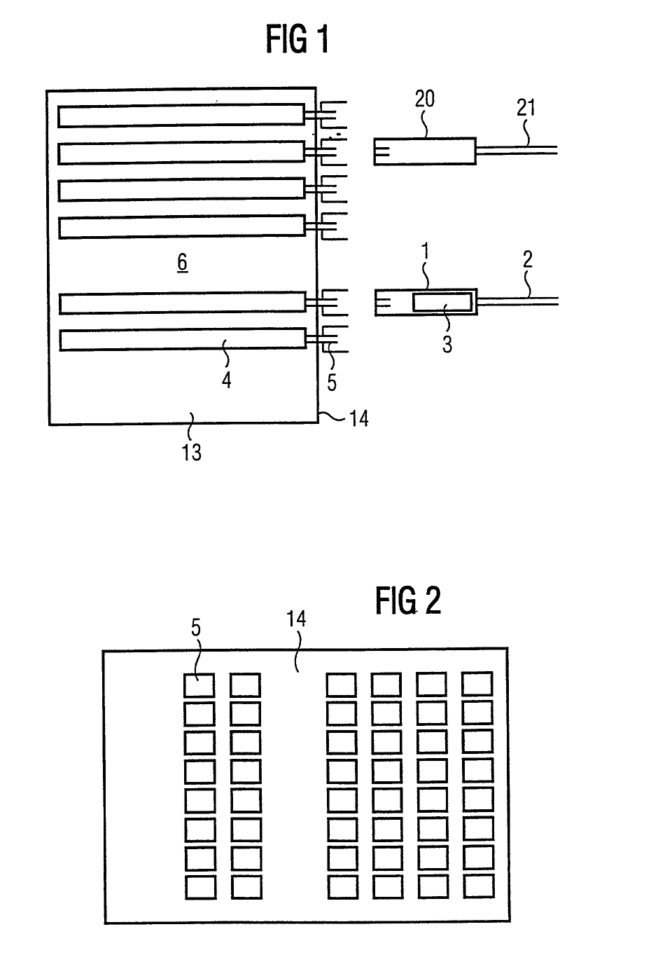

FIG. 1 shows in schematic form a mounting rack 6 belonging to a digital switching center. Located in the housing of the mounting rack 6 are the subassemblies 4 on which the digital switching is carried out. The subassemblies 4 each have electrical contact-making devices, which are available to further contact-making devices 5 via the mounting rack 6. The electrical contact-making devices 5 are the interfaces at which the digital data, either electrical or electrooptically converted, are accepted into the switching matrix 6 or output from the latter via an electrical (20) or optical plug (1).

In one aspect of the present invention, the electrooptical converter 3 is advantageously now displaced outward, specifically in such a way that said converter can be integrated into an optical plug 1. Electrooptical converters with small dimensions of this type can be obtained on the market, such as the optical module NetLight™ type 1430G5 or 1430H5 from Lucent or, for example, V23818-N15-L17 or V23818-N305-V15 from Infineon.

The transmission of the digital data is therefore carried out either electrically, to be specific with an electrical plug 20 via an electrical contact-making device 5, now standardized, on the rear 14 of the housing of the mounting rack 6, or it is carried out optically via an optical plug 1.

Connected to the rear of the optical plug 1 are, for example, two optical cables 2 for bidirectional transmission. At the front end, it has a geometry which is compatible with the electrical contact-making device 5 of the mounting rack 6.

The electrical plug 20 is connected, for example, to two electrical signal conductors 21. The front end is compatible with that of the optical plug 1.

In FIG. 2, the pattern of electrical contact-making devices 5 on the rear 14 of the switching matrix of the digital switching center is illustrated. The electrical contact-making devices are standardized and connected to the subassemblies 4 at the rear.

The cross-sectional area of the electrical contact-making devices 5, and therefore the dimension of the pattern, is defined by the cross-sectional dimension of the electrical 20 and optical plugs 1, and is given by the dimensions of the respective components in the plugs.

The component which limits the cross section is at present the electrooptical converter 3. For example, a model of one of the above-mentioned types has dimensions such that the cross section of an optical plug has a cross-sectional width of about 20 mm and a cross-sectional height of about 12.5 mm. Therefore, four optical plugs can be arranged in a row over a length of five centimeters.

Since the electrical contact-making device for both plugs is standardized, the cross section of the electrical plug is made equal to the dimensions of the optical plug.

The handling of the connections is to be emphasized. The plugs lie much too closely beside one another to make it possible, for example, to replace the electrical cables 21. Only by means of removal, for example with special tongs, is access to the actual customer connection possible. A minimum vertical spacing between the individual connections is therefore no longer necessary.

The advantage of an arrangement modified in this way resides in the more compact construction of the customer interface and the possible flexible use of optical and electrical interfaces. Even in the event of failure of an individual optical component, it is not necessary for an entire subassembly, with the electrooptical converter on it, to be replaced, but merely the appropriate optical component, that is to say the optical plug 1.

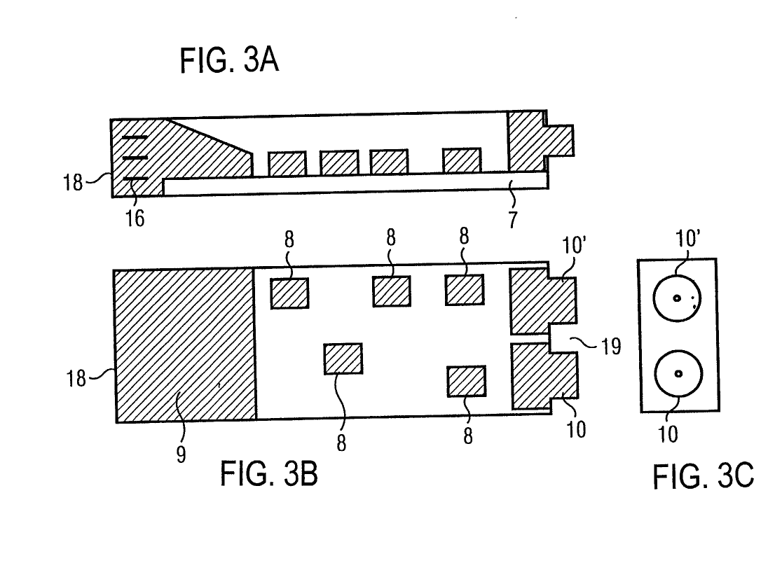

FIG. 3A is a cross-sectional side view, FIG. 3B is a cross-sectional plan view and FIG. 3C is a front, customer connection side, view of an electrical plug/transceiver used as a coupling element between the customer side and switching matrix.

The bottom of the electrical plug is formed by an electrical printed circuit board 7, which connects an electrical connecting plug 10, 10′ on the customer side to an electrical plug 9 that is located on the side of the electrical contact-making device.

Arranged on the printed circuit board 7 are electrical active and/or passive components 8, such as diodes, resistors, ICs, etc. The active components include, for example, an active data splitter in the upstream direction and, for example, a pin diode switch in the downstream direction. In addition, in order to take account of lightning protection and measures for supply voltage redundancy, capacitors and Schottky diodes are provided.

The electrical connecting plug on the front end 19 on the customer side is a double two-pole plug 10, 10′, to which the electrical signal conductors 21 are connected. It is possible, for example, for SMB, SMC or other small angled plugs to be used.

It should be noted, however, that the connection of the customer cable can also be made via short cables instead of an electrical connecting plug.

The arrangement of the plug contacts 16 on the plug 9 on the mounting rack side is compatible with that of the electrical contact-making device.

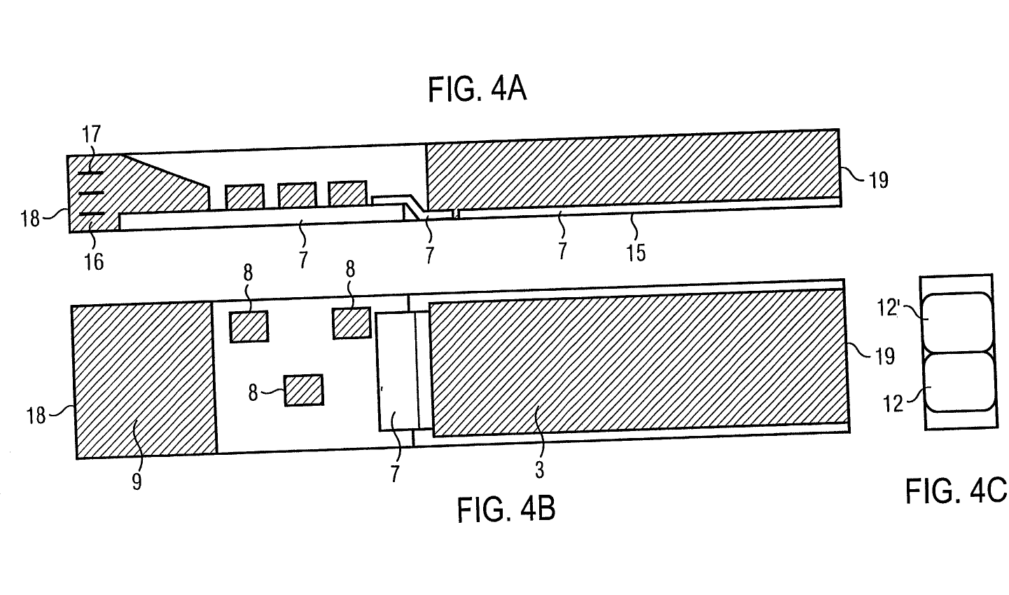

FIG. 4A is a side cross-sectional view, FIG. 4B is a cross-sectional plan view and FIG. 4C is a front view on the customer side, of an optical plug/transceiver used as coupling element between the customer side and switching matrix.

As in the case of the electrical plug, the bottom of the optical plug is also again formed by a printed circuit board 7 on which electrical active and/or passive components 8 such as diodes, resistors, ICs etc. are likewise arranged. However, the lightning protection measures in the form of capacitors and Schottky diodes do not have to be transferred.

In addition, in contact with the printed circuit board 7 is an electrooptical converter 3 with plug contacts 15, which are either plugged onto the printed circuit board 7 or soldered on. On the front end 19 on the customer side there are likewise contacts 12, 12′ to which the optical signal cables are connected.

The printed circuit board 7 takes care of converting the contacts of the electrooptical converter 3 to the plug contacts 16. It is expedient that the electrooptical converter 3 is accommodated on its long side in order that the plug cross section is as small as possible. The plug contacts 15 of the electrooptical converter 3 therefore stand upright on the axis of the plug with the plug contacts 16. In order to provide a connection between the respective plug contacts, use is made of the printed circuit board 7, which, where possible, can also be designed to be flexible.

The plug 9 on the mounting rack side of the optical plug is structurally identical to the plug 9 on the rack mounting side of the electrical connector, since both plugs must be compatible with the electrical contact-making devices.

In this case, at least one plug contact 17 at the front end 18 of the plug is used for the voltage supply of active components in the plug. In particular, the electrooptical converter 3 is supplied with voltage through the plug contact 17.

As mentioned above, the dimension of the electrooptical converter limits the cross-sectional dimensions of the optical and therefore also of the electrical plug. The respective length of the two plugs can be different.

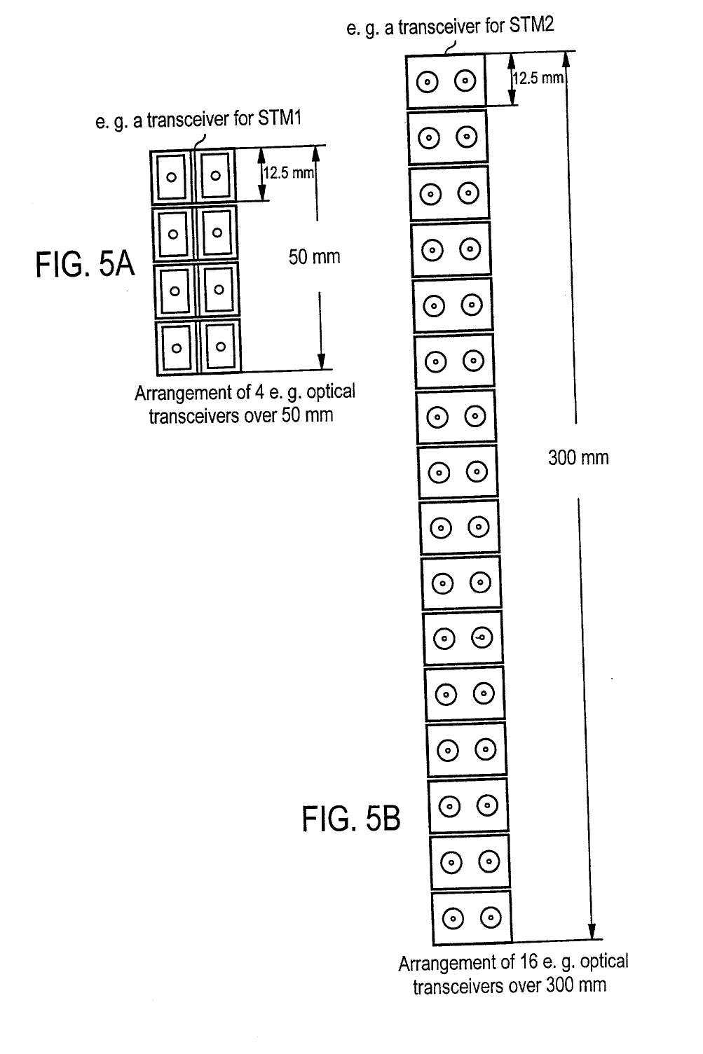

FIG. 5A shows how four optical plugs/transceivers can be arranged over a length of 50 mm, and FIG. 5B shows how sixteen electrical plugs/transceivers can be arranged over a length of 300 mm. FIGS. 5A and 5B are given by example, not limitation.

The invention has been described in detail with particular reference to preferred embodiments thereof and examples, but it will be understood that variations and modifications can be effected within the spirit and scope of the invention.

What is claimed is:

1. A plug for the electrical connection of mounting racks in the switching sector, comprising:
a connector device to make connection with at least one optical transmission cable;
a housing; and
an electrooptical converter accommodated in the housing of the plug.

2. The plug as claimed in claim 1, wherein
the electrooptical converter has an electrical contact-making device,
the plug further comprises:
plug contacts at a front end of the plug; and
a printed circuit board to connect the electrical contact-making device and the plug contacts.

3. The plug as claimed in claim 2, wherein components comprising at least one of active components and passive components are arranged on the printed circuit board.

4. The plug as claimed in claim 3, wherein the components include at least one of data partitioning components, data selection components and fault monitoring components.

5. The plug as claimed in claim 2, wherein at least some of the plug contacts at the front end of the plug are designed for a voltage supply to active components in the plug.

6. The plug as claimed in claim 3, wherein at least some of the plug contacts at the front end of the plug are designed for a voltage supply to active components in the plug.

7. The plug as claimed in claim 4, wherein at least some of the plug contacts at the front end of the plug are designed for a voltage supply to active components in the plug.

8. A system for optional electrical or optical connection, comprising:
a plug comprising:
a connector device to make connection with at least one optical transmission cable;
a housing; and
an electrooptical converter accommodated in the housing of the plug; and
at least one mounting rack of a switching system, the mounting rack having standardized electrical contact-making devices for the electrical or optical connection to the plub.

9. The system as claimed in claim 8, wherein the mounting rack has electrical contact-making devices with a pin allocation that is compatible with the electrical and optical connections, so that, on each electrical contact-making device of the mounting rack, an optical or electrical connection can be made as desired.

10. The system as claimed in claim 8, wherein
the electrooptical converter has an electrical contact-making device,
the plug further comprises:
plug contacts at a front end of the plug; and
a printed circuit board to connect the electrical contact-making device and the plug contacts.

11. The system as claimed in claim 10, wherein components comprising at least one of active components and passive components are arranged on the printed circuit board.

12. The system as claimed in claim 11, wherein the components include at least one of data partitioning components, data selection components and fault monitoring components.

13. The system as claimed in claim 10, wherein at least some of the plug contacts at the front end of the plug are designed for a voltage supply to active components in the plug.

14. The system as claimed in claim 11, wherein at least some of the plug contacts at the front end of the plug are designed for a voltage supply to active components in the plug.

15. The system as claimed in claim 12, wherein at least some of the plug contacts at the front end of the plug are designed for a voltage supply to active components in the plug.
